(19) United States
(12) Patent Application Publication
(10) Pub. No.: US 2024/0132323 A1
(43) Pub. Date: Apr. 25, 2024

(54) Liner reel, cassette comprising said liner reel, let off station and method for collecting a liner

(71) Applicant: VMI Holland B.V., EPE (NL)

(72) Inventors: Mattheus Jacobus KAAGMAN, EPE (NL); Quinten Matthijs BERGMANS, EPE (NL); Herman Sebastiaan SCHERPENHUIZEN, EPE (NL)

(21) Appl. No.: 18/278,611

(22) PCT Filed: Feb. 16, 2022
(86) PCT No.: PCT/NL2022/050078

§ 371 Date: Aug. 22, 2023

(30) Foreign Application Priority Data
Mar. 1, 2021 (NL) 2027677

(51) Int. Cl. B65H 75/24

(52) U.S. Cl. CPC B65H 75/2455; B29D 30/0016; B65H 2801/93

(57) ABSTRACT

Disclosed is a liner reel, a cassette, a let off station and a method for collecting a liner, wherein the liner reel has a core and a shell that is concentrically mountable to said core for rotation together with said core about a liner reel axis, wherein the shell has a collection wall that extends in a circumferential direction about the liner reel axis when the shell is mounted to the core, wherein the collection wall is arranged for receiving the liner, wherein the core has a support wall extending in the circumferential direction for supporting the collection wall at least with a vector component in a radial direction perpendicular to the liner reel axis, wherein the collection wall is at least partially contractible in said radial direction when the shell is removed from the core.

### BACKGROUND

The invention relates to a liner reel, a cassette comprising said liner reel, a let off station for receiving said cassette and a method for collecting a liner. Let off stations are used to supply stock material, such as strips or tire components, to a tire building machine. In particular, the invention relates to the supply of RFID tags to a tire building machine, for embedding said RFID tag into a green or unvulcanized tire.

The stock material is stored in several windings on a stock reel, ready to be unwound and supplied to the tire building machine by the let off station. The windings are separated by one or more layers of liner to prevent that subsequent windings adhere or stick to each other. The aforementioned liner reel is used to collect the liner when the stock material is being unwound.

### SUMMARY OF THE INVENTION

A disadvantage of the known liner reel is that—during the collection of the liner on the liner reel—the windings of the liner that are already collected around the liner reel become increasingly tighter as a result of the tension added with every new turn of the liner. When the liner reel is full, it needs to be emptied before it can be reused. It can however be very difficult to remove the tightly wound liner quickly and in an orderly fashion. It is common practice that an operator tries to cut his way through the windings of the liner up to the core of the liner reel to release the tension and remove the liner. In this process, there is a great risk of damaging the liner reel and/or injury to the operator. The process can also be time consuming and frustrating for the operator. Moreover, the liner cannot be removed as one continuous piece. Instead, it is cut into many short pieces of waste that can be easily lost in the machine and/or pollute the factory.

A further disadvantage of the known liner reel is that it is difficult to attach the leading end of a new liner to the empty liner reel. Currently, the leading end of the liner is attached to the core of the liner reel with a piece of adhesive tape.

It is an object of the present invention to provide a liner reel, a cassette comprising said liner reel and a method for collecting a liner, wherein the application of the liner to the liner reel and/or the removal of the liner from the liner reel can be improved.

According to a first aspect, the invention provides a liner reel for collecting a liner, wherein the liner reel comprises a core and a shell that is concentrically mountable to said core for rotation together with said core about a liner reel axis, wherein the shell comprises a collection wall that extends in a circumferential direction about the liner reel axis when the shell is mounted to the core, wherein the collection wall is arranged for receiving the liner, wherein the core comprises one or more support members for supporting the collection wall with at least a vector component in a radial direction perpendicular to the liner reel axis, wherein said collection wall is at least partially contractible in said radial direction when the shell is removed from the core, wherein the shell has a first side that is open in a mounting direction parallel to the liner reel axis so that the shell can be slid over the core and a second side facing away from the core in a removal direction opposite to the mounting direction when the shell is mounted to the core, wherein the shell comprises a plurality of first slots dividing said collection wall in the circumferential direction into a plurality of wall segments that are interconnected only at the second side, wherein the plurality of wall segments are individually flexible in the radial direction at the first side, wherein the shell further comprises a front wall interconnecting the plurality of wall segments at the second side, wherein the front wall comprises a plurality of second slots which are continuous with the plurality of first slots and which extend in the radial direction towards the liner reel axis when the shell is mounted to the core.

The collected liner will be packed increasingly tighter around the liner reel as a result of the tension added with every new turn or winding of the liner, thereby making it very difficult to remove the liner from the full liner reel. In the liner reel according to the present invention, the shell can conveniently be removed in the removal direction. The retraction of the core from the shell allows the wall segments of the collection wall to at least partially contract in the radial direction, under the influence of the tension exerted by the windings onto said collection wall. As a result, the collection wall can assume an at least partially contracted, conical and/or tapering configuration, which can effectively release the tension exerted by the tightly packed windings of liner on said collection wall. The reduced tension, contact and/or friction between the collection wall and the liner, enables the operator to easily remove the collected liner from the shell, i.e. without the use of tools and/or the need for cutting into the windings.

The first slots between the wall segments can provide sufficient space for the wall segments to flex radially inwards without colliding, thus providing the necessary flexibility to release the tension between the windings and the collection wall. The front wall can keep the wall segments together and provide a base relative to which the wall segments can flex. As a result of the second slots, the front wall can at least partially flex together with the wall segments of the collection wall, moving the flexing axis for the respective wall segments closer to the liner reel axis. The flexing of the front wall about the flexing axis close to the first liner reel axis contracts or reduces the diameter of the collection wall not only at the distal ends of the wall segments at the first side of the shell, but also at or near the front wall at the second side of the shell. Hence, the tension can be released across the entire collection wall and the collected liner can be removed more easily from the shell.

In one embodiment the collection wall is discontinuous in the circumferential direction and is, as a result thereof, contractible in the radial direction. The collection wall may for example be contracted by flexing distinct parts of the collection wall radially inwards. Alternatively, the collection wall may be contracted both radially and circumferentially by assuming a spiral shape.

In another embodiment, the plurality of first slots extends mutually parallel and parallel to the liner reel axis when the shell is mounted to the core. The wall segments can thus have a substantially parallel configuration.

In another embodiment the one or more support members comprises a support wall extending in the circumferential direction. In contrast to a number of strategically placed support ribs, the circumferentially extending support wall can provide a stable support for the collection wall along a substantial part of the circumference thereof.

Preferably, the shell is mountable to said core in a mounting direction parallel to the liner reel axis, wherein the support wall tapers conically with respect to the liner reel axis in a removal direction opposite to the mounting direction. When the core is retracted from within the collection wall, the tapering support wall can gradually allow the collection wall to radially contract.

More preferably, the collection wall tapers in the mounting direction. Hence, the thickness of the collection wall in the radial direction can be reduced in the same direction in which support wall tapers, so that the outside of said collection wall can remain in a more or less cylindrical or straight cylindrical configuration when the shell is mounted to the core.

More in particular, the collection wall defines an externally facing collection surface, wherein the collection wall tapers at a taper angle that is chosen such that, when the collection wall is supported on the conically tapering support wall, the collection surface is cylindrical or substantially cylindrical. Hence, the liner can be collected uniformly around a substantially cylindrical collection surface, as if the liner reel according to the present invention was a conventional liner reel, quod non.

In another embodiment the liner reel further comprises a retaining member for retaining the shell in an axial direction parallel to the liner reel axis to the core when the shell is mounted to said core. The retaining member can prevent that the shell is accidentally or unintentionally removed from the core during the collection of the liner.

In another embodiment the liner reel comprises a first side flange and a second side flange projecting in the radial direction outside of the collection wall on opposite sides of the collection wall in an axial direction parallel to the liner reel axis when the shell is mounted to the core, wherein the first side flange is associated with the core and the second side flange is associated with the shell.

In another embodiment the liner reel comprises one of a spline bushing and a spline shaft at the liner reel axis for coupling the core to the other of the spline bushing and the spline shaft. The spline bushing and the features related thereto may also be applied independently of the distinctive collection wall features of the liner reel according to the first aspect of the present invention, i.e. in a conventional liner reel.

Preferably, the spline bushing is arranged for receiving the spline shaft in a receiving direction parallel to the liner reel axis, wherein the spline bushing is movable in the receiving direction from a coupling position to a retracted position, wherein the liner reel further comprises a biasing member to bias the spline bushing from the retracted position towards the coupling position. The spline shaft can be fully accommodated behind the retracted spline bushing, thus allowing the cassette to be fitted to the receiving frame, even if the spline shaft and the spline bushing are misaligned. As soon as the spline shaft is rotated into an angular position in which the male splines of the first spline shaft are aligned with the female splines inside the spline bushing, the spline bushing can be returned to the coupling position and into engagement with the first spline shaft.

According to a second aspect, the invention provides a cassette comprising the liner reel according to the first aspect of the invention as a first liner reel for collecting a first liner, wherein the cassette comprises a cassette frame for holding the first liner reel and a stock reel in tandem.

The cassette comprises the liner reel according to the first aspect of the present invention and therefore has the same technical advantages, which will not be repeated hereafter. The stock reel and the first liner reel can work in tandem to unwind one or more tire components and simultaneously collect a liner used to separate consecutive layers and/or windings of the tire component.

In an embodiment the cassette further comprises a liner reel according to the first aspect of the invention as a second liner reel for collecting a second liner. The second liner can be used to collected a further liner, i.e. in a case in which the one or more tire component on the stock reel are sandwiched between an inside liner and an outside liner.

In another embodiment the first liner reel comprises a ratchet gear rotatable about the liner reel axis of said first liner reel, wherein the cassette comprises a pawl that is rotatable relative to the cassette frame to form a ratchet mechanism together with the ratchet gear. The ratchet mechanism can prevent the first liner reel from rotating in an unwinding direction when the first liner reel is disconnected from its drive, i.e. when it is undriven. The liner can be attached more easily to the first liner reel when it is unable to unexpectedly rotate in the unwinding direction, i.e. when it can only be wound further onto the first liner reel.

In another embodiment the first liner reel comprises one of a spline bushing and a spline shaft at the liner reel axis for coupling the core to the other of the spline bushing and the spline shaft, wherein the spline bushing is arranged for receiving the spline shaft in a receiving direction parallel to the liner reel axis, wherein the spline shaft is movable in a direction opposite to the receiving direction from a coupling position to a retracted position, wherein the cassette further comprises a biasing member to bias the spline shaft from the retracted position towards the coupling position. The spline bushing can be fully accommodated in front of the retracted spline shaft, thus allowing the cassette to be fitted to the receiving frame, even if the spline shaft and the spline bushing are misaligned. As soon as the spline shaft is rotated into an angular position in which the male splines of the first spline shaft are aligned with the female splines inside the spline bushing, the spline shaft can be returned to the coupling position and into engagement with the spline bushing.

According to a third aspect, the invention provides a let off station comprising the cassette according to the second aspect of the invention and a receiving frame for mounting of said cassette, wherein the let off station comprises a first spline shaft for driving the first liner reel. The first spline shaft can control the rotation of the first liner reel to control the winding and/or collection of the liner onto said first liner reel.

Preferably, the first liner reel comprises a spline bushing at the liner reel axis of the first liner reel for coupling the core to the first spline shaft, wherein the spline bushing is arranged for receiving the first spline shaft in a receiving direction parallel to the liner reel axis of the first liner reel, wherein the spline bushing is movable in the receiving direction from a coupling position to a retracted position over a distance that is at least equal to the length of the first spline shaft that is received into the spline bushing in the receiving direction when the cassette is mounted to the receiving frame and the spline bushing is aligned with the first spline shaft in the coupling position. As such, the spline bushing can be pushed inwards by the first spline shaft and stay ahead of the first spline shaft when it is inserted in the receiving direction while being misaligned. Hence, the inserted length of the first spline shaft can be fully accommodated behind the retracted spline bushing, thus allowing the cassette to be fitted to the receiving frame, even if the first spline shaft and the spline bushing are misaligned.

In a further embodiment the let off station comprises a second spline shaft, spaced apart and parallel to the first spline shaft, for driving a second liner reel. Hence, both spline shafts can be inserted simultaneously in the same direction into the spline bushings of the respective liner reels.

Preferably, the first spline shaft has an external diameter, and the spline bushing has an internal diameter, wherein the internal diameter is at least one-hundred-and-three percent of the external diameter. This tolerance between the spline bushing and the spline shaft, which is larger than commonly used for spline mechanisms, can absorb minor misalignments as a result of tolerances between the cassette and the receiving frame, and/or tolerances between the first spline shaft and the second spline shaft. In particular, it may be difficult for an operator to correctly align both spline shafts with the spline bushing of the respective liner reels. The increased tolerances helps the operator to find the correct alignment and/or to slot the cassette into place.

In a further embodiment thereof the first spline shaft comprises male splines having a male spline width, wherein the spline bushing comprises female splines having a female spline width, wherein the female spline width is at least one-hundred-and-five percent of the male spline width. This tolerance between the male and female splines, which is larger than commonly used for spline mechanisms, can further aid with the aforementioned placement of the cassette onto the receiving frame.

In a further embodiment thereof the let off station further comprises a liner reel drive for driving the first liner reel and a second liner reel, wherein the liner reel drive is arranged for driving one of the first liner reel and the second liner reel faster than the other of the first liner reel and the second liner reel. The speed difference can at least partially compensate for slight length difference between the liner that is wound radially on the outside of the tire component on the stock reel and the liner that is wound radially on the inside of the tire component on the stock reel.

Preferably, the liner reel drive comprises a first pulley connected to the first spline shaft to rotate the first liner reel, a second pulley connected to a second spline shaft to rotate the second liner reel and an endless drive element arranged in a loop around the first pulley and the second pulley, wherein one of the first pulley and the second pulley has a diameter greater than the diameter of the other of the first pulley and the second pulley. The pulley with the smaller diameter will automatically rotate slightly faster than the pulley with the larger diameter.

According to a fourth aspect, the invention provides a method for collecting a liner on a liner reel according to the first aspect of the invention, wherein the method comprises the steps of:
mounting the shell concentrically to the core;
connecting a leading end of the liner to the shell;
rotating the shell together with the core; and
receiving windings of the liner around the collection wall;
wherein the collection wall at least partially contracts in the radial direction when the shell is removed from the core, wherein the method further comprises the step of:
removing the windings of the liner from the shell when the collection wall is at least partially contracted in the radial direction.

The method relates to the practical implementation of the liner reel according to the first aspect of the invention and therefore has the same technical advantages, which will not be repeated hereafter.

Preferably, the shell comprises a first slot extending in the collection wall parallel to the liner reel axis when the shell is mounted to the core, wherein the step of connecting the leading end of the liner to the shell comprises the steps of:
inserting the leading end of the liner through the first slot so that it protrudes through the collection wall in the radial direction at the inside of said collection wall when the shell is not yet mounted to the core; and
clamping the leading end between the collection wall and the core when the shell is mounted to the core.

The leading end can thus be securely attached or connected to the liner reel, to allow for the rest of the outside liner to be collected by winding. In particular, the leading end can be attached simply by clamping, i.e. without using tools or adhesives.

According to an unclaimed fifth aspect, the invention provides a stock reel mount for mounting a stock reel to a cassette, wherein the stock reel mount is rotatable about a stock reel axis and comprises a clamping wall that extends in a circumferential direction about the stock reel axis and a wedge that is movable in a wedge direction parallel to the stock reel axis for expanding the clamping wall in a radial direction perpendicular to the stock reel axis from a release diameter to a clamping diameter.

In conventional cassettes or cartridges for let off stations that supply tire components to a tire building machine, the stock reel is mounted to the cassette with the use of tools. The stock reel mount according to the present invention allows for simply forcing the wedge into the clamping wall to expand said clamping wall into clamping contact with the inside of the stock reel. The stock reel can thus be easily mounted by an operator without using tools.

It is noted that, although the stock reel mount has some features that are similar to the features of the previously discussed liner reel, its function is completely different. In particular, the stock reel mount is used to mount the stock reel by clamping, whereas the stock reel itself is more or less conventional.

Preferably, the clamping wall is discontinuous in the circumferential direction and is, as a result thereof, expandable in the radial direction. The clamping wall may for example be expanded by flexing distinct parts of the clamping wall radially outwards.

In a further embodiment the clamping wall has a first side that is open in a release direction opposite to the wedge direction for receiving the wedge and a second side facing away from the wedge in the wedge direction, wherein the stock reel mount comprises a plurality of first slots in the clamping wall dividing said clamping wall in the circumferential direction into a plurality of wall segments that are interconnected only at the second side, wherein the plurality of wall segments are individually flexible in the radial direction at the first side. The wall segments can thus be individually expanded by the wedge towards the stock reel to clamp said stock reel.

Preferably, the plurality of first slots extends mutually parallel and parallel to the stock reel axis. The wall segments can thus have a substantially parallel configuration.

Additionally or alternatively, the stock reel mount further comprises a rear wall interconnecting the plurality of wall segments at the second side. The rear wall can keep the wall segments together and provide a base relative to which the wall segments can flex.

More preferably, wherein the stock reel mount comprises a plurality of second slots in the rear wall which are continuous with the plurality of first slots and which extend in the radial direction towards the stock reel axis. As a result, the rear wall can at least partially flex together with the wall segments of the clamping wall, moving the flexing axis for the respective wall segments closer to the stock reel axis.

In another embodiment the wedge tapers conically with respect to the stock reel axis in the wedge direction. The wedge diameter increases as the wedge is inserted further into the clamping wall in the wedge direction, thereby forcing the wall segments further and further outwards, until they contact the stock reel.

In another embodiment the stock reel mount further comprises a retaining member for retaining the wedge in the wedge direction with respect to the clamping wall. The retaining member can effectively prevent that the stock reel is unintentionally or accidentally released from the stock reel mount.

Preferably, the retaining member is a turning knob, preferably a torque limited turning knob. The turning knob can be manually operated. When the turning knob is torque limited, excessive force on the wedge and thus the clamping wall can be prevented.

In yet another embodiment the stock reel mount further comprises a key for engaging a key slot in the stock reel. The optional key can further prevent that the stock reel slips on or over the stock reel mount in the circumferential direction.

According to an unclaimed sixth aspect, the invention provides a peeler for peeling a liner from a tire component, wherein the peeler comprises a lower peeler member and an upper peeler member that is tiltable about a peeler axis towards the lower peeler member, wherein the peeler further comprises one or more first peeling rollers that form a first peeling edge at one of the lower peeler member and the upper peeler member.

The radius of the first peeling edge is sufficiently small to peel off and/or pull away the liner from the tire component. However, due to the relatively small radius, the friction between the liner and the first peeling edge is increased. Conventionally, peelers are provided with integral, fixed or stationary peeling edges. The one or more first peeling rollers according to the present invention can effectively reduce friction between the liner and the first peeling edge, thereby preventing inconsistent peeling of the liner from the tire component or even breaking of the liner.

Preferably, the peeler further comprises one or more second peeling rollers that form a second peeling edge at the other of the lower peeler member and the upper peeler member. Hence, friction at both peeling edges can be reduced.

In a further embodiment the one or more first peeling rollers are rotatable about a first roller axis parallel to the peeler axis. The liners can thus be fed through the peeler without any significant twisting.

In a further embodiment the one or more first peeling rollers are freely rotatable. The one or more first peeling rollers can thus rotate passively together with and/or follow the liner as it is pulled along said one or more first peeling rollers.

In a further embodiment the one or more first peeling rollers comprises a plurality of first peeling rollers that are coaxially mounted. The individual first peeling rollers may rotate at slightly different rotational velocity.

In a further embodiment the one or more first peeling rollers have a roller diameter that is less than twenty millimeters and preferably less than ten millimeters. Said roller diameter is sufficiently small to peel off and/or pull away the liner from the tire component.

In another embodiment the first peeling edge is arranged for peeling of the liner from the tire component, wherein the peeler further comprises a return roller that is arranged for receiving the liner from the first peeling edge and for returning the liner to the tire component downstream of said first peeling edge before permanently peeling off said liner. This configuration may prevent that the tire component is pulled with the liner into the small gap between the first peeling edge and receiving members for the tire component downstream of said first peeling edge.

According to an unclaimed seventh aspect, the invention provides a let off station for supplying a tire component to a tire building machine, wherein the let off station comprises a supply table for presenting the tire component to the tire building machine, wherein the supply table is rotatable about a vertical axis between a receiving position for receiving the tire component in a receiving orientation and a supply position for presenting the tire component in a supply orientation.

The let off station according to the seventh aspect is arranged for receiving a cassette in which the orientation of the tire components, in particular RFID tags, is such that the longitudinal direction of the tire components is parallel or substantially parallel to the stock reel axis when the tire components are still on the stock reel. The advantage of such an orientation is that more tire components can be stored on the same stock reel. The tire building machine is configured to receive the tire components in an orientation with the longitudinal direction thereof perpendicular to the stock reel axis. Hence, the rotatable supply table can change the orientation of the tire components prior to supplying said tire components to the tire building machine.

Preferably, the receiving position and the supply position are offset over an angle in the range of eighty to one-hundred degrees about the vertical axis. More preferably, the receiving position and the supply position are offset over an angle of ninety degrees about the vertical axis. Hence, the orientation of the tire components can be changed from parallel or substantially parallel to the stock reel axis to perpendicular or substantially perpendicular to the stock reel axis.

In a further embodiment the let off station further comprises an actuator for rotating the supply table about the vertical axis between the receiving position and the supply position. The rotation of the supply table can thus be mechanically controlled, remotely controlled and/or automatically controlled.

Preferably, the actuator is a linear actuator for moving the supply table along a linear path, wherein the supply table is rotatable about the vertical axis relative to the linear actuator, wherein the supply table comprises a cam at a position spaced apart from the vertical axis, wherein the let off station further comprises an arm for contacting the cam when the supply table is moved along the linear path, for causing the rotation of the supply table about the vertical axis. The supply table can thus both be moved linearly and rotated as a result of said linear movement, without needing additional actuators or motors.

More preferably, the arm is stationary. Hence, the rotation comes solely from the fact that the arm is positioned in the trajectory of the cam when the supply table is moved along the linear path. The combined linear movement and rotation can thus be actuated with a single, relatively simple linear actuator.

According to an unclaimed eighth aspect, the invention provides a method for supplying a tire component to a tire building machine using the let off station according to the seventh aspect of the invention, wherein the method comprises the step of receiving the tire component on the supply table in the receiving position and subsequently rotating the supply table about the vertical axis to the supply position.

The method according to the eighth aspect of the invention relates to the practical implementation of the let off station according to the seventh aspect of the invention and thus has the same technical advantages, which will not be repeated hereafter.

Preferably, the tire component is an RFID tag that is elongated in a longitudinal direction, wherein the RFID tag is transferred onto the supply table in a transfer direction with the longitudinal direction of the RFID tag transverse or perpendicular to said transfer direction, wherein the supply table, after receiving the RFID tag onto the supply table in the transfer direction, is rotated from the receiving position to the supply position until the longitudinal direction of the RFID tag is parallel or substantially parallel to the transfer direction.

According to an unclaimed ninth aspect, the invention provides a method for locating and measuring a tire component, wherein the method comprises the steps of:
providing a tire component on a support surface, wherein the tire component has a contour, a bottom surface, a top surface and a thickness between the bottom surface and the top surface;
locating the tire component on the support surface by moving a laser projection across the support surface until the laser projection intersects with the contour of the tire component; and
determining the height of the support surface with the laser projection;
moving the laser projection onto the tire component;
determining the height of the top surface of the tire component; and
calculating the thickness of the tire component by subtracting the height of the support surface from the height of the top surface.

The same laser projection can thus be used both for locating the tire component, in particular an RFID tag, on the support surface as well as for measuring the height, a thickness or a height profile of the tire component. This can improve the accuracy of the pickup and the subsequent placement of the tire component.

Preferably, the laser projection is a laser spot. The laser spot can be used to accurately determine the position of the contour of the tire component.

In one embodiment, the support surface is a supply member of a cassette that supplies the tire component to a tire building machine. Hence, the position and/or the thickness can be determined at the cassette.

Alternatively, the support surface is a substrate, in particular a rubber substrate, to which the tire component is applied. Hence, the position and/or the thickness can be determined at the substrate.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows an isometric view of a let off station according to a first embodiment of the invention, comprising a cassette with a peeler, a stock reel, a first liner reel and a second liner reel;

FIG. 2 shows a front view of the cassette according to FIG. 1;

FIG. 3 shows a top view of the cassette according to FIG. 1;

FIGS. 4A, 4B and 4C show isometric views of the steps of collecting and removing a liner from the first liner reel according to FIG. 1;

FIG. 4D shows a cross section of a part of the first liner reel according to FIG. 4C;

FIG. 5A shows a cross section of the let off station according to FIG. 1 at the location of the first liner reel;

FIG. 5B shows a cross section of an alternative let off station according to a second exemplary embodiment of the invention;

FIG. 6 shows a detail of the first liner reel of FIG. 1;

FIG. 7 shows a rear view of the let off station according to FIG. 1;

FIG. 8 shows an isometric view of the stock reel according to FIG. 1;

FIG. 9 shows a cross section of the let off station according to FIG. 1 at the location of the stock reel;

FIG. 10 shows a front view of the peeler according to FIG. 1;

FIG. 11 shows an isometric view of the peeler according to FIG. 10;

FIG. 12 shows a front view of a further alternative cassette according to a third exemplary embodiment of the invention;

FIGS. 13A and 13B show top views of a further alternative let off station according to a fourth embodiment of the invention, comprising a supply table in a receiving position and a supply position, respectively; and

FIGS. 14A-14E show isometric views of the let off station according to FIG. 1 during the steps of a method for locating and measuring a tire component.

### DETAILED DESCRIPTION OF THE INVENTION

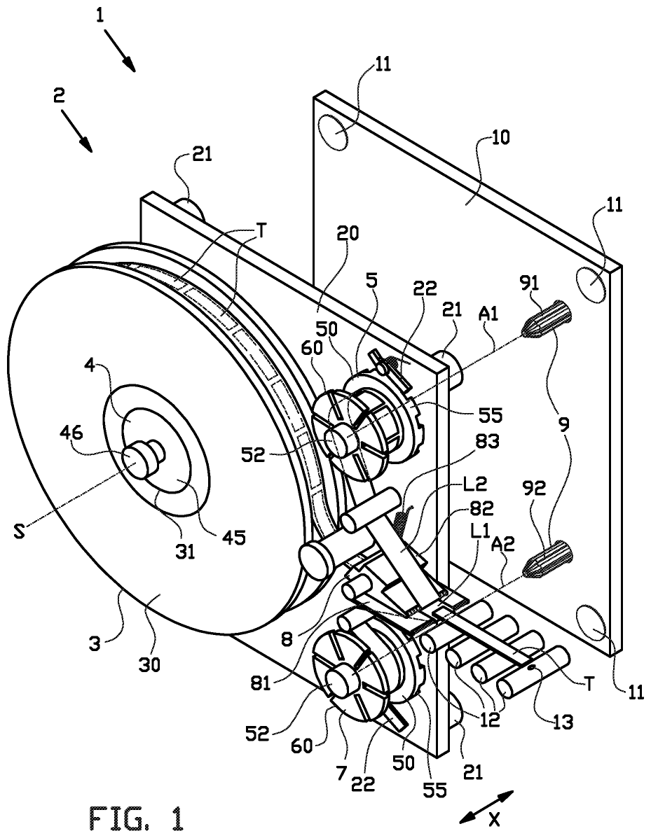

FIG. 1 shows a let off station 1 according to a first exemplary embodiment of the invention. The let off station 1 is used to supply stock material, such as strips or tire components, to a tire building machine (not shown). In particular, the invention relates to the supply of RFID tags T to a tire building machine, for embedding said RFID tags T into a green or unvulcanized tire.

The let off station 1 is arranged or configured for receiving or holding a cartridge or cassette 2. The cassette 2 comprises a cassette frame 20 that is arranged or configured for holding a stock reel 3 and one or more liner reels 5, 7. Each liner reel 5, 7 is held in a tandem configuration with the stock reel 3, i.e. each liner 5, 7 is held in substantially the same plane in a position behind the stock reel 3. The stock reel 3, the first liner reel 5 and the second liner reel 7 are rotatable about a stock reel axis S, a first liner reel axis A1 and a second liner reel axis A2, respectively, which are mutually parallel and/or perpendicular to a plane defined by the cassette frame 20.

The stock reel 3 is configured for holding a stock material wound in several windings around said stock reel 3 in a manner known per se. In this exemplary embodiment, the RFID tags T are carried on a continuous length of an inside liner L1, with the RFID tags T spaced apart from each other in a circumferential direction about the stock reel 3. The inside liner L1 can prevent that the RFID tags T in different windings stick or adhere to each other. The term ‘inside’ refers to the radially inner position of the inside liner L1 on the stock reel 3 relative to the RFID tags T it is carrying. In this particular example, the RFID tags T are sandwiched or enclosed between the inside liner L1 and an outside liner L2 opposite to the inside liner L1. The term ‘outside’ refers to the radially outer position of the outside liner L2 on the stock reel 3 relative to the RFID tags T it is covering.

The one or more liner reels 5, 7 are arranged or configured for winding up or collecting the inside liner L1 and optionally the outside liner L2 as the stock material is being unwound from the stock reel 3, in a manner that will be described hereafter in more detail. Referring to FIG. 1, the liner reel 5 at the top of the cassette frame 20 is hereafter referred to as the ‘first’ liner reel 5 and the liner reel 7 at the bottom of the cassette frame 20 is hereafter referred to as the ‘second’ liner reel 7. It is however observed that these liner reels 5, 7 are interchangeable.

The cassette 2 is insertable into or mountable to the let off station 1 to supply the stock material, i.e. the RFID tags T, to a tire building machine. When the stock reel 3 is empty, the cassette 2 may be easily removed from the let off station 1 and replaced by a similar or identical, full cassette (not shown). To facilitate the mounting and removal of the cassette 2, the let off station 1 is provided with a receiving frame 10 and a plurality of coupling members 11 located at or on said receiving frame 10. Similarly, the cassette 2 is provided with a plurality of complimentary or compatible coupling members 21 to interact or engage with the coupling members 11 of the let off station 1. Preferably, the coupling members 11, 21 are of a quick-coupling type, i.e. a type that does not require tools to achieve the coupling. In this particular example, the coupling members 11, 21 are magnetic. Hence, a simple alignment and/or proximity between the coupling members 11, 21 is sufficient to achieve the coupling.

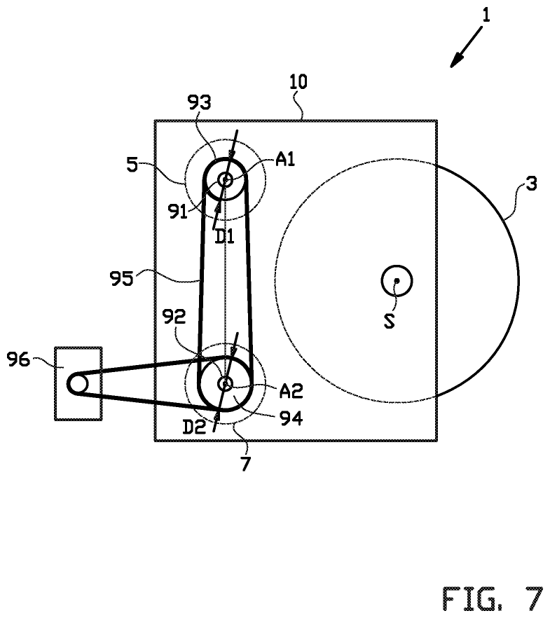

As shown in FIGS. 1 and 7, the let off station 1 comprises a liner reel drive 9 for driving the rotation the first liner reel 5 and the second liner reel 7 when the cassette 2 is received in or mounted to the receiving frame of the let off station 1. As best seen in FIG. 1, the liner reel drive 9 comprises a first shaft 91 and a second shaft 92 to drive the first liner reel 5 and the second liner reel 7, respectively. As best seen in FIG. 7, the let off station 1 is provided with a first drive pulley 93 and a second drive pulley 94 connected to the first shaft 91 and the second shaft 92, respectively, at the rear of the receiving frame 11 to drive the rotation of the respective shafts 91, 92. The first drive pulley 83 and the second drive pulley 94 are interconnected by a drive belt 95. One of the drive pulleys 93, 94, in this case the second drive pulley 94 is driven by a motor 96.

Note that, in this exemplary embodiment, the first drive pulley 93 has a first pulley diameter D1 and the second drive pulley 94 has a second pulley diameter D2, wherein the pulley diameter D1, D2 of the liner reel 5, 7 that is collecting the outside liner L2, in this example the first pulley diameter D1 of the first liner reel 5, is slightly smaller than the diameter D1, D2 of the liner reel 5, 7 that is collecting the inside liner L1, in this example the second pulley diameter D2 of the second liner reel 7. Hence, the liner reel drive 9 is configured to drive the first liner reel 5 at a slightly faster rotation speed than the second liner reel 7, thereby compensating for the slight length difference between the outside liner L2 and the inside liner L1. It will be clear to one skilled in the art that the speed difference between the liner reels 5, 7 can be obtained in different ways, i.e. by using a gear transmission with a specific transmission ratio or by using individual drives. These variations are also encompassed by the scope of the present invention.

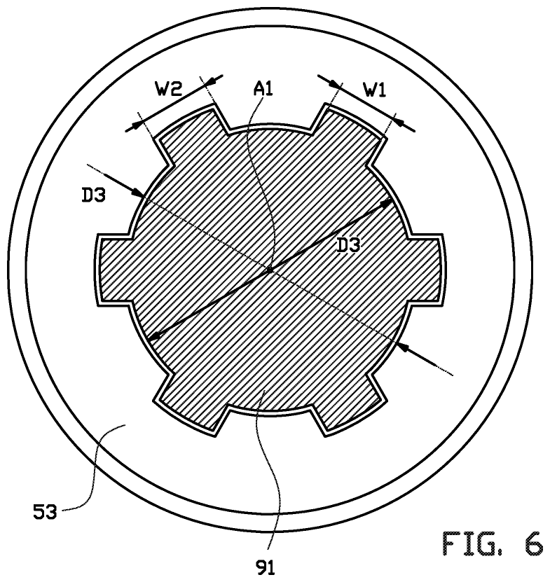

As best seen in FIGS. 1 and 6, the shafts 91, 92 are spline shafts 91, 92, i.e. shafts provided with longitudinally or axially extending teeth, also called male splines, that are arranged to engage with correspondingly shaped grooves, also called female splines, formed in the liner reels 5, 7. Once engaged, the spline shafts 91, 92 can effectively and reliably transfer torque onto the respective liner reels 5, 7.

The details of the cassette 2 will now be discussed in more detail.

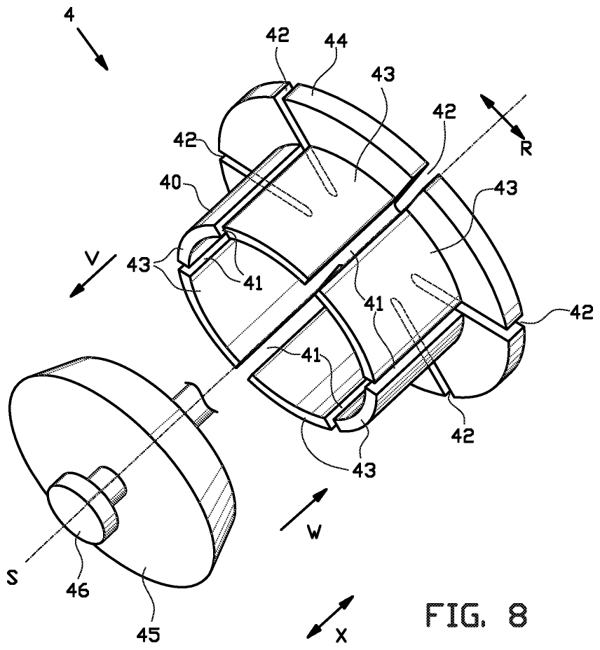

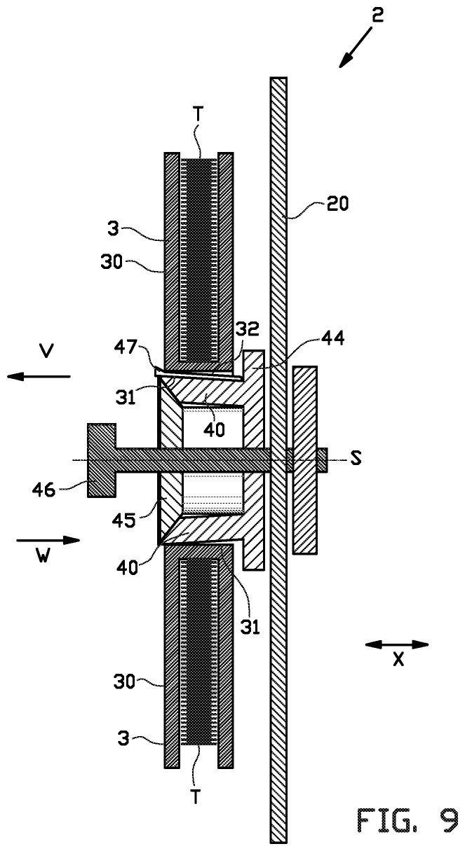

As shown in FIG. 1, the stock reel 3 comprises a stock reel body 30 that is rotatable about the stock reel axis S. The stock reel body 30 has a central mounting opening 31 concentric to the stock reel axis S. As shown in FIGS. 8 and 9, the cassette 2 comes with a stock reel mount 4 for mounting the stock reel 3 to the cassette 2, in particular to the cassette frame 20. The stock reel mount 4 comprises a clamping wall 40 that extends in a circumferential direction about the stock reel axis S. The clamping wall 40 is cylindrical or substantially cylindrical. As shown in FIG. 8, the clamping wall 40 is interrupted or discontinuous in a circumferential direction about the stock reel axis S and is, as a result thereof, expandable in a radial direction R perpendicular to said stock reel axis S. In particular, the stock reel mount 4 comprises a plurality of first slots 41 in the clamping wall 40 dividing said clamping wall 40 in the circumferential direction into a plurality of wall segments 43.

In this example, the plurality of first slots 41 extends mutually parallel and parallel to the stock reel axis S. The first slots 41 may alternatively extend obliquely to the stock reel axis S, and may even alternate each other in direction. The clamping wall 40 has a first side that is open in a direction parallel to the stock reel axis S. The stock reel mount 4 further comprises a rear wall 44 interconnecting the plurality of wall segments 43 at a second side, opposite to the first side. The plurality of wall segments 43 are individually flexible in the radial direction R at the first side.

In this exemplary embodiment, the stock reel mount 4 further comprises a plurality of second slots 42 in the rear wall 44. The second slots 42 are continuous with or form a continuation of the plurality of first slots 41 in the clamping wall 40. The second slots 42 extend in the radial direction R, i.e. radially inwards, towards the stock reel axis S. As a result of the radially inward second slots 42, the rear wall 44 can at least partially flex together with the wall segments 43 of the clamping wall 40, moving the flexing axis for the respective wall segments 43 closer to the stock reel axis S.

The stock reel mount 4 further comprises a wedge that is movable in a wedge direction W parallel to the stock reel axis S into the clamping wall 40 through the open first side thereof. The wedge 45 is conical and/or tapers in the wedge direction W. The wedge 45 is dimensioned to at least partially fit inside the clamping wall 40 in the wedge direction W. When inserted into the clamping wall 40 through the open first side thereof, the wedge 45 can force the clamping wall 40 to expand and/or deform in the radial direction R from a release diameter towards a clamping diameter that is larger than the release diameter. At the release diameter, the circumference of the clamping wall 40 is smaller than the inner diameter of the mounting opening 31 in the stock reel 3. Hence, the stock reel 3 can be released and/or removed from the stock reel mount 4. At the clamping diameter, the clamping wall 40 is arranged to clampingly abut the inside of the mounting opening 31 of the stock reel 3, as schematically shown in FIG. 9. In other words, the clamping wall 40 may be radially expanded into contact with the inside of the mounting opening 31 to retain the stock reel 3 to the stock reel mount 4 solely through friction between the clamping wall 40 and the mounting opening 31.

The stock reel mount 4 further comprises a retaining member 46 for retaining the wedge 45 in the wedge direction W to or with respect to the clamping wall 40. In this exemplary embodiment, the retaining member 46 is a turning knob, in particular a knurled turning knob, that engages with a threaded member associated with the clamping wall 40. Preferably, the retaining member 46 is a torque limited turning knob to prevent excessive force being applied to the wedge 45.

As shown in FIG. 9, the stock reel mount 4 may optionally comprise a key 47 for engaging a key slot 32 in the stock reel 3. The engagement between the key 47 and the key slot 32 can further prevent slipping of the stock reel 3 relative to the stock reel mount 4 in the circumferential direction about the stock reel axis S.

When changing an empty stock reel 3 for a full one, an operator can simply retract the wedge 45 in a release direction V opposite to the wedge direction W to release the empty stock reel 3 and—once the empty stock reel 3 is replaced by a full one—reinsert the wedge 45 into the clamping wall 45, thereby forcing the clamping wall 45 to expand to the clamping diameter and retain the new stock reel 3. The stock reel 3 can thus be easily replaced without needing tools.

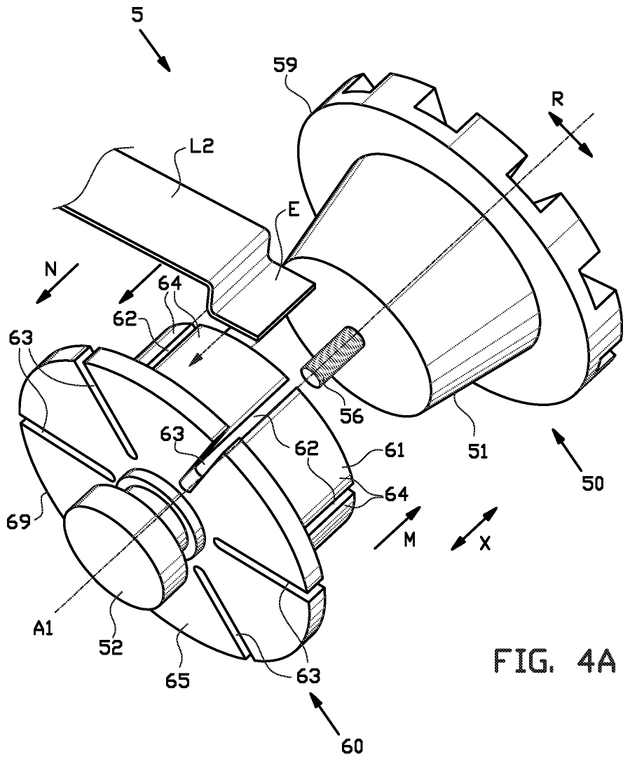

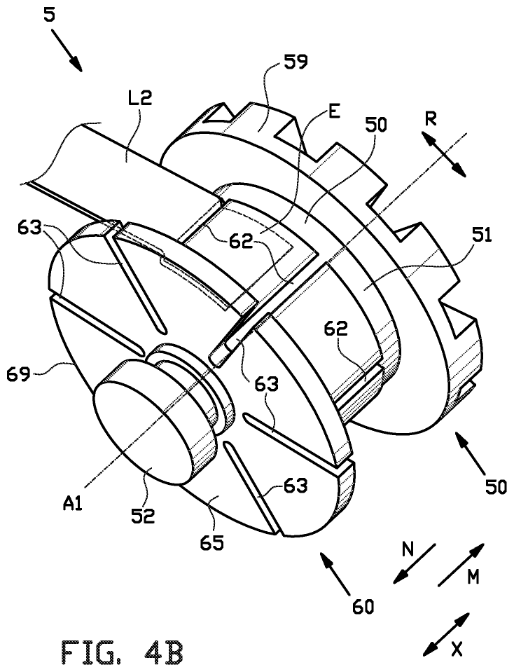

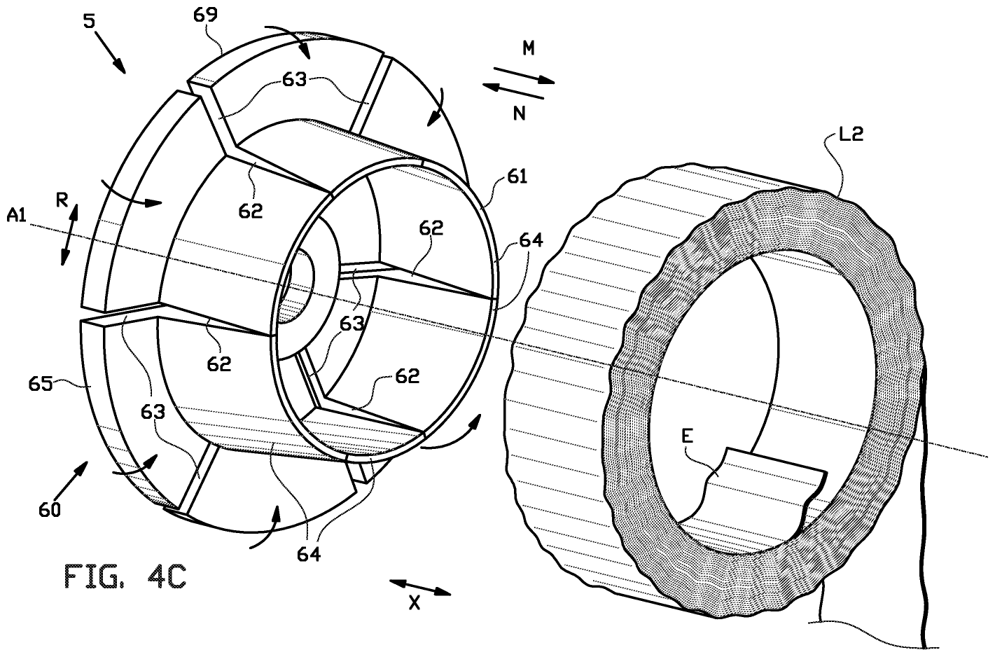

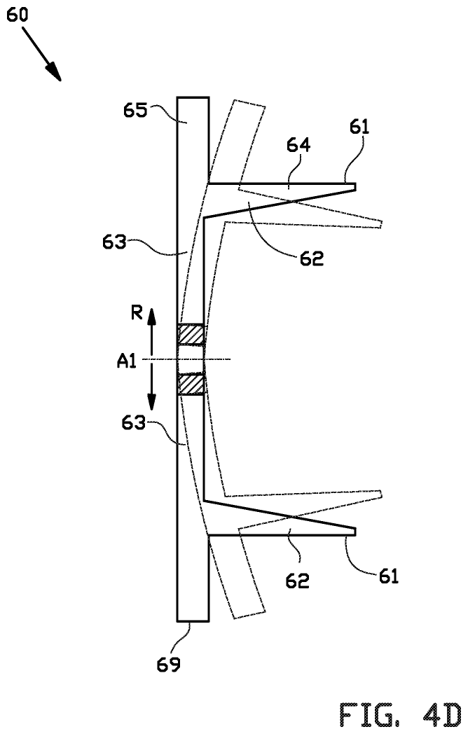

FIGS. 4A, 4B and 4C show the first liner reel 5 in more detail. The second liner reel 7 is similar or identical to the first liner reel 7 and will not be discussed in detail hereafter. All features of the first liner reel 5 apply mutatis mutandis to the second liner reel 7.

As shown in FIG. 4A, the liner reel 5 comprises a core 50 and a cap, sleeve or a shell 60. The shell 60 is coaxially and/or concentrically mountable in a mounting direction M parallel to the first liner reel axis A1 to said core 50 for rotation together with said core 50, i.e. rotation in unison with said core 50, about the first liner reel axis A1. The shell 60 comprises a collection wall 61 that extends in a circumferential direction about the first liner reel axis A1 when the shell 60 is mounted to or coaxially aligned with said the core 50. In the mounted state, the shell 60 overlaps with the core 50 in an axial direction X parallel to the first reel axis A1. In this example, the core 50 comprises a support wall 51 extending in a circumferential direction about the first liner reel axis A1 for supporting and/or abutting the collection wall 61 relative to the first liner reel axis A1, in particular in a direction substantially perpendicular or transverse to the first liner reel axis A1, or in a direction with at least with a vector component in a radial direction R perpendicular to the first liner reel axis A1. The support wall 51 tapers conically with respect to the first liner reel axis A1 in a removal direction N opposite to the mounting direction M. Hence, the support wall 51 abuts the collection wall 61 in a direction transverse to the first liner reel axis A1.

As shown in FIG. 4A, the collection wall 61 is arranged for receiving windings of the outside liner L2 while the outside liner L2 is being collected on the first liner reel 5. The collection wall 61 is at least partially flexible, deformable, compressible or contractible in the radial direction R, i.e. radially inwards, when the shell 60 is removed from the core 50, to allow for easy removal of the collected windings of the outside liner L2 from said collection wall 61.

In particular, the collection wall 61 is interrupted or discontinuous in the circumferential direction and is, as a result thereof, contractible in the radial direction R.

In this particular example, as best seen in FIG. 4C, the shell 60 has a first side that is open in the mounting direction M so that the shell 60 can be slid over the core 50 and a second side facing away from the core 50 in a removal direction N opposite to the mounting direction M when the shell 60 is mounted to or coaxially aligned with the core 50. The shell 60 is provide with a front wall 65 at the second side. The shell 60 comprises a plurality of first slots 62 dividing the collection wall 61 in the circumferential direction into a plurality of wall segments 64 that are interconnected only at the second side, i.e. at the front wall 65. In this example, the first slots 62 extend mutually parallel and/or parallel to the first liner reel axis A1 when the shell 60 is mounted to the core 50. The first slots 62 may alternatively extend obliquely to the first liner axis A1, and may even alternate each other in direction. The wall segments 64 are individually deformable or flexible in the radial direction R at the first side, thereby effectively contracting the diameter of the collection wall 61 at said first side. The first slots 62 provide space for the wall segments 64 towards each other as the collection wall 61 is contracted in the radial direction R.

Consequently, the collection wall 61 can contract from a substantially cylindrical configuration, as shown in FIGS. 4A and 4B, to at least partially conical configuration, as shown in FIG. 4C, tapering in the mounting direction M, i.e. from the second side towards the first side. The wall segments 64 of the collection wall 61 are resiliently flexible, meaning that they will return to a natural or unstressed position as shown in FIG. 4A when no radially inward forces are exerted onto the wall segments 64.

Instead of the circumferentially extending support wall 51, the core 50 may comprises one or more strategically positioned support members, such as ribs (not shown), providing local support to the collection wall 61 in the aforementioned direction. For example, one support member may be provided for individually and locally supporting a respective one of the wall segments 64.

As shown in FIG. 4A, the shell 60 is optionally provided with a plurality of second slots 63 in the front wall 65 which are continuous with or form a continuation of the first slots 62 in the collection wall 61. The second slots 63 extend in the radial direction R towards the first liner reel axis A1 when the shell 60 is mounted to or coaxially aligned with the core 50. As a result of the radially inward second slots 63, the front wall 65 can at least partially flex together with the wall segments 64 of the collection wall 61, moving the flexing axis for the respective wall segments 64 closer to the first liner reel axis A1. In particular, as shown in FIG. 4D in an exaggerated manner, the flexing of the front wall 65 about the flexing axis close to the first liner reel axis A1 contracts or reduces the diameter of the collection wall 61 not only at the distal ends of the wall segments 64 at the first side of the shell 60, but also at or near the front wall 65 at the second side of the shell 60.

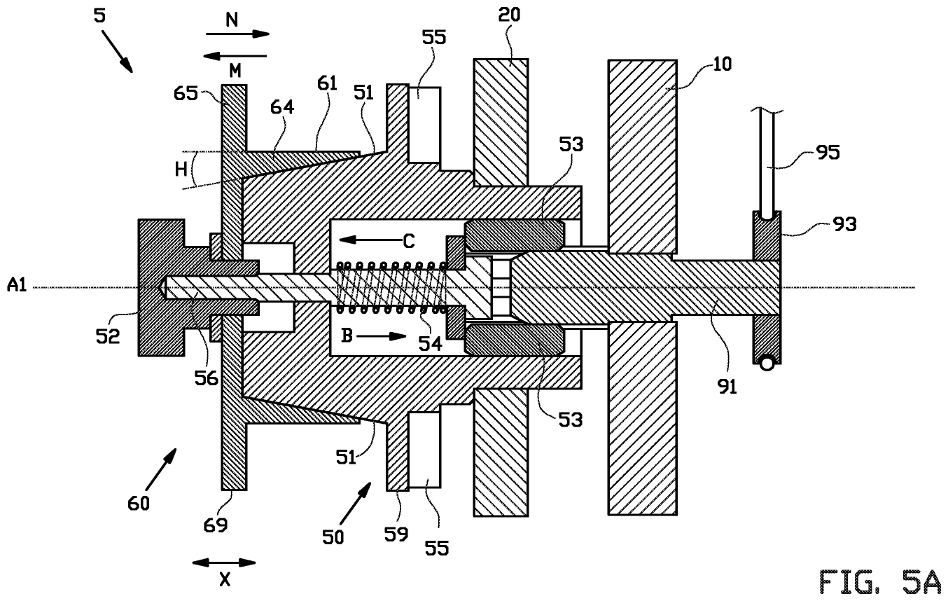

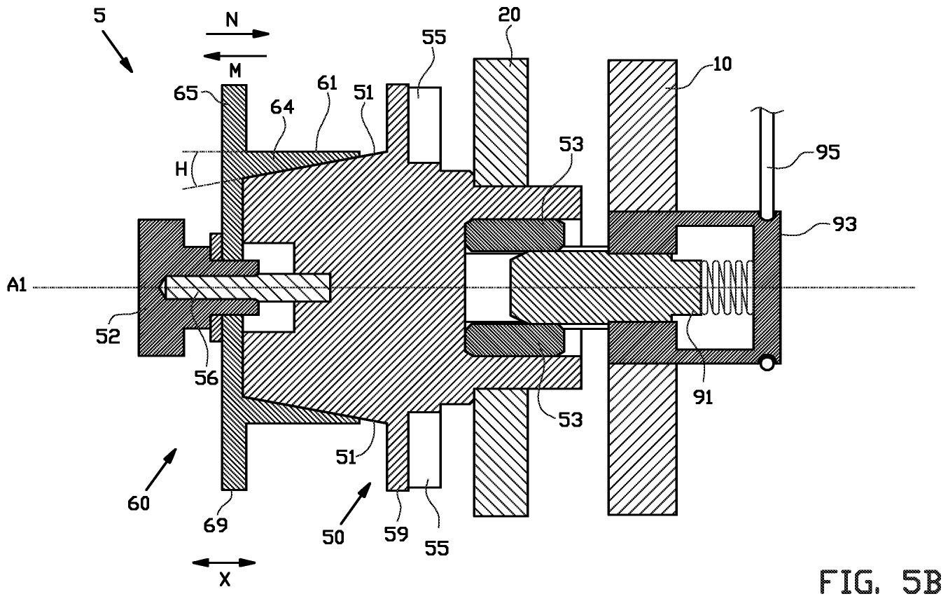

As best seen in the cross section of FIG. 5A, the collection wall 61 defines an externally facing collection surface 66. The collection wall 61 tapers in the mounting direction M. In other words, the wall segments 64 have a thickness in the radial direction R that decreases in the mounting direction M. Preferably, the collection wall 61 tapers at a taper angle H that is equal or substantially equal to the conicity of the support wall 51 of the core 50. This allow the collection surface 66 to extend in a cylindrical or substantially cylindrical orientation when the shell 60 is mounted to the core 50.

Other ways of contracting the collection wall 61 may be envisioned, such as the use of an uninterrupted collection wall of a compressible or at least partially foldable material or the use of a discontinuous collection wall that can be contracted both circumferentially and radially into a spiral configuration. These variations are also encompassed by the scope of the present invention.

As shown in FIG. 4B, the first liner reel 5 further comprises a retaining member 52 for retaining the shell 60 in the axial direction X to the core 50. In this particular example, the retaining member 52 is a turning knob that is arranged to engage with a threaded element 56 associated with the core 50. Preferably, the retaining member 52 can be operated manually, so that no tools are needed to mount the shell 60 to the core 50.

As best seen in FIG. 5A, the first liner reel 5 is provided with a spline nut or spline bushing 53 at or concentric to the first liner reel axis A1 for coupling the core 50 to a first spline shaft 91. The spline bushing 53 forms the female splines for engaging with the aforementioned male splines on the first spline shaft 91, as already discussed in the part of the description that introduced the liner reel drive 9. The spline bushing 53 is arranged for receiving the first spline shaft 91 in a receiving direction C parallel to the first liner reel axis A1 when the cassette frame 20 is aligned with and mounted to the receiving frame of the let off station 1, as for example shown in FIG. 3. When the first spline shaft 91 and the spline bushing 53 of the first liner reel 5 are properly engaged and/or meshing, the first spline shaft 91 can effectively transfer torque onto the spline bushing 53, thereby rotating the first liner reel 5.

However, in some cases, it may be difficult to initially align the spline bushing 53 correctly with the first spline shaft 91. This is especially the case when the operator has to simultaneously align the first liner reel 5 with the first spline shaft 91 and the second liner reel 7 with the second spline shaft 92. Because of tolerances between the spline shafts 91, 92, tolerances between the liner reels 5, 7 and/or inaccuracies during the mounting of the cassette 2 to the let off station 1, the male splines on the first spline shaft 91 may be misaligned with the female splines in the spline bushing 53 of the first liner reel 5, or the spline shaft 91 may be misaligned relative to the spline bushing 53 of the first liner reel 5 altogether.

The applicant has discovered that the spline bushing 53 of the first liner reel 5 and the first spline shaft 91 do not need to be aligned correctly as long as they are allowed to fall into engagement as soon as the first spline shaft 91 is first rotated. To absorb the initial misalignment, the spline bushing 53 is movable with respect core 50 in the receiving direction C from a coupling position into a retracted position. As such, the spline bushing 53 can be pushed inwards by the first spline shaft 91 and stay ahead of the first spline shaft 91 when it is inserted in the receiving direction C while being misaligned. In particular, the spline bushing 53 is movable in the receiving direction C over a distance that is at least equal to the length of the first spline shaft 91 that is received into the spline bushing 53 in the same receiving direction C when the cassette 2 is mounted to the receiving frame 10. Hence, the inserted length of the first spline shaft 91 can be fully accommodated behind the retracted spline bushing 53, thus allowing the cassette 2 to be fitted to the receiving frame 10, even if the first spline shaft 91 and the spline bushing 53 are misaligned.

As further shown in FIG. 5A, the first liner reel comprises a biasing member 54 to urge or bias the spline bushing 53 in a biasing direction B opposite to the receiving direction C from the retracted position towards the coupling position. Hence, as soon as the first spline shaft 91 is rotated into an angular position in which the male splines of the first spline shaft 91 are aligned with the female splines inside the spline bushing 53, the spline bushing 53 is returned to the coupling position and into engagement with the first spline shaft 91.

FIG. 5B shows an alternative first liner reel 105 and liner reel drive 109 for driving said alternative first liner reel 105. The first liner reel 105 and liner reel drive 109 differ from the aforementioned first liner reel 5 and the liner reel drive 9 in that the first spline shaft 191 is retractable instead of the spline bushing 153. In particular, the spline bushing 153 is fixed in the receiving direction C relative to the core 150 and/or may be an integral part of said core 150, whereas the first spline shaft 191 is received in a housing 195 that is connected to or integral with the first drive pulley 193. The first spline shaft 191 is retractable in a direction opposite to the receiving direction C relative to the housing 195 and rotatable together with said housing 195 about the first liner axis A1, i.e. through interaction between the male splines of the first spline shaft 191 and female splines (not shown) in the housing 195. The liner reel drive 109 further comprises a biasing member 196 for biasing the first spline shaft 191 in the receiving direction C.

It will further be apparent to one skilled in the art that in each of the aforementioned embodiments, the spline bushing 53, 153 may alternatively be a spline shaft and that the first spline shaft 91, 191 may alternatively be a spline bushing.

To further absorb initial misalignment between the first spline shaft 91 and the spline bushing 53 of the first liner reel 5, the tolerances between said first spline shaft 91 and the spline bushing 53 are increased. In particular, as shown in FIG. 6, the first spline shaft 91 has an external diameter D3. The spline bushing 53 has an internal diameter D4. The internal diameter D4 is at least one-hundred-and-four (104) percent, and preferably one-hundred-and-five (105) percent of the external diameter D3. In this particular example, the external diameter D3 is sixteen (16) millimeters, and the internal diameter D4 is seventeen millimeters (17) (approximately one-hundred-and-six (106) percent of the external diameter D3).

Additionally or alternatively, the male splines of the first spline shaft 91 have a male spline width W1, the female splines of the spline bushing 53 have a female spline width W2 and the female spline width W2 is at least one-hundred-and-five (105) percent, and preferably at least one-hundred-and-ten (110) percent of the male spline width W1. In this exemplary embodiment, the male spline width W1 is three and six tenths (3.6) of a millimeter and the female spline width is four (4) millimeters (approximately one-hundred-and-eleven (111) percent of the male spline width). These tolerances can account for any tolerances in the relative positions of the spline shafts 91, 92 and/or the relative positions of the liner reels 5, 7.

As best seen in FIG. 5A, the first liner reel 5 comprises a first side flange 59 and a second side flange 69 projecting in the radial direction R outside of the collection wall 61 on opposite sides of the collection wall 61 in the axial direction X when the shell 60 is mounted to the core 50. In this particular example, the first side flange 59 is associated with the core 50 and the second side flange 69 is associated with the shell 60. More in particular, the second side flange 69 is formed at or part of the front wall 65. When the shell 60 is removed from the core 50, as shown in FIG. 4C, the only flange remaining is the flange 69 on the second side of the shell 60, i.e. at the front wall 65. Thus, the windings of the outside liner L2 can be easily removed from the collection wall 61 without interference from the first flange 59.

As shown in FIG. 1, the first liner reel 5 comprises a ratchet gear 55 rotatable about the first liner reel axis A1. The cassette 2 comprises a pawl 22 that is rotatable relative to the cassette frame 20 to form a ratchet mechanism together with the ratchet gear 55. The ratchet mechanism prevents the first liner reel 5 from rotating in an unwinding direction when the first liner reel 5 is disconnected from the liner reel drive 9. Note that the first liner reel 5 may still be freely rotated in a winding direction to attach and/or wind the first part of the outside liner L2 around the first liner reel 5 during the setup of the cassette 2.

A method for collecting the outside liner L2 on the first liner reel 5 with the use of the aforementioned let off station 1 will be elucidated briefly below with reference to FIGS. 4A, 4B and 4C.

FIG. 4A shows the situation in which the shell 60 is removed and/or spaced apart from the core 50. The shell 60 is empty, i.e. any previously collected liner is removed. The shell 60 is now ready to be fitted or mounted to the core 50 to form the first liner reel 5. Prior to or simultaneously with the mounting of the shell 60 to the core 50, a leading end E of the outside liner L2 is positioned relative to said shell 60 and/or said core 50 to be connected to the first liner reel 5. In this particular example, the leading end E is aligned with one of the first slots 62 in the shell 60 to be inserted through into said one first slot 62. The leading end E is inserted through said one first slot 62 so that it protrudes through the collection wall 61 in the radial direction R at the inside of said collection wall 61 when the shell 60 is not yet mounted to the core 50. The protruding part of the leading end E can subsequently be clamped between the collection wall 61 and the supporting wall 51 of the core 50 when the shell 60 is mounted to said core 50.

FIG. 4B shows the situation in which the shell 60 is mounted to the core 50 with the leading end E of the outside liner L2 (shown in dashed lines) clamped between the collection wall 61 and the supporting wall 51. The leading end E of the outside liner L2 is now securely attached or connected to the first liner reel 5, to allow for the rest of the outside liner L2 to be collected by winding, i.e. by rotation of the shell 60 together with the core 50 and by receiving windings of the outside liner L2 around the collection wall 61. The leading end E can thus be attached without using tools or adhesives.

FIG. 4C shows the situation in which several windings of the outside liner L2 have been collected on the collection wall 61. In the prior art liner reels, windings would become increasingly tighter as a result of the tension added with every new turn or winding of the liner, thereby making it very difficult to remove the liner from the full liner reel. In the first liner reel 5 according to the present invention, the shell 60 can conveniently be removed in the removal direction N. The retraction of the core from the shell 60 allows the wall segments 64 of the collection wall 61 to at least partially contract in the radial direction R, in particular at or near the first side thereof of the shell 60. As a result, the collection wall 61 can assume an at least partially conical or tapering configuration, which effectively releases the tension exerted by the tightly packed windings of outside liner L2 on said collection wall 61. As a result of the reduced tension, contact and/or friction between the collection wall 61 and the outside liner L2, the windings of said outside liner L2 can be easily removed from the shell 60, i.e. without the use of tools and/or the need for cutting into the windings.

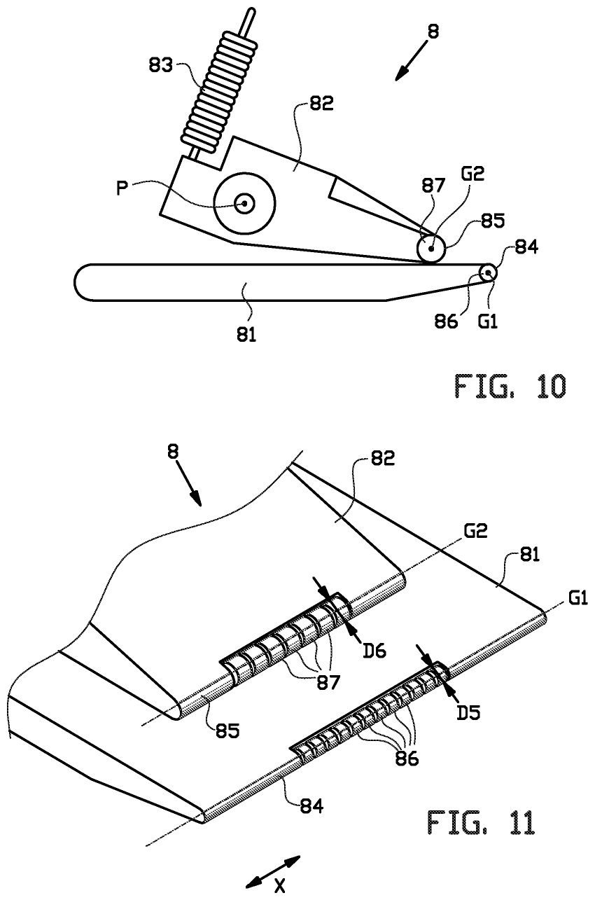

As shown in FIG. 1, the cassette 2 further comprises a peeler 8 for peeling the inside liner L1 and/or the outside liner L2 from the tire component, in particular the RFID tag T. The peeler 8 is shown in more detail in FIGS. 10 and 11. The peeler 8 comprises a lower peeler member 81 for peeling the inside liner L1 and an upper peeler member 82 for peeling the outside liner L2. At least one of the lower peeler member 81 and the upper peeler member 82 is movable towards the other of the lower peeler member 81 and the upper peeler member 82 to account for the combined thickness of the liners L1, L2 and the tire component that is fed between the respective peeler members 81, 82. In this exemplary embodiment, the upper peeler member 82 is tiltable about a peeler axis P towards the lower peeler member 81. Preferably, the peeler 8 is provided with a bias member 83 to urge or bias the upper peeler member 82 against the lower peeler member 81.

The lower peeler member 81 is provided with a lower peeling edge 84 around which the inside liner L1 is pulled. Similarly, the upper peeler member 82 is provided with an upper peeling edge 85 around which the outside liner L2 is pulled. The radii of the lower peeling edge 84 and the upper peeling edge 85 are sufficiently small to peel off and/or pull away the inside liner L1 and the outside liner L2, respectively, from the tire component. However, due to the relatively small radius, the friction between the liners L1, L2 and the respective peeling edge 84, 85 is increased.

Conventionally, peelers are provided with integral, fixed or stationary peeling edges. As best seen in FIG. 11, the peeler 8 according to the present invention is provided with a plurality of first peeling rollers 86 that form or define the lower peeling edge 84 at the lower peeler member 81 and the upper peeler member 82. The plurality of first peeling rollers 86 are freely rotatable to move with the inside liner L1 as it is being pulled around the lower peeling edge 84. The plurality of first peeling rollers 86 are preferably identical or at least have the same diameter. The plurality of first peeling rollers 86 are coaxially mounted to rotate about a common first roller axis G1. The first roller axis G1 is parallel or substantially parallel to the peeler axis P. Alternatively, a single first peeling roller (not shown) may be provided.

Preferably, the peeler 8 further comprises a plurality of second peeling rollers 87 that form or define the second peeling edge 85 at the upper peeler member 82. The plurality of second peeling rollers 87 are coaxially rotatable about a second roller axis G2. The second roller axis G2 is parallel or substantially parallel to the peeler axis P. Again, a single second peeling roller (not shown) may be provided.

The one or more first peeling rollers 86 and/or the one or more second peeling rollers 87 have a relatively small roller diameter D5, D6, in particular less than twenty millimeters and preferably less than ten millimeters, to effectively peel off the respective liner L1, L2.

As best seen in FIG. 1, directly downstream of the peeler 8, the cassette 2 is provided with one or more receiving members 12, in this exemplary embodiments in the form of receiving rollers, to support the tire component T once it has been stripped of its liners L1, L2. In particular, the receiving rollers together form a small roller conveyor. The last roller may be provided with a sensor 13 to detect the presence of the tire component T and trigger the subsequent pickup of said tire component T from the receiving members 12 by a gripper of the tire building machine (not shown).

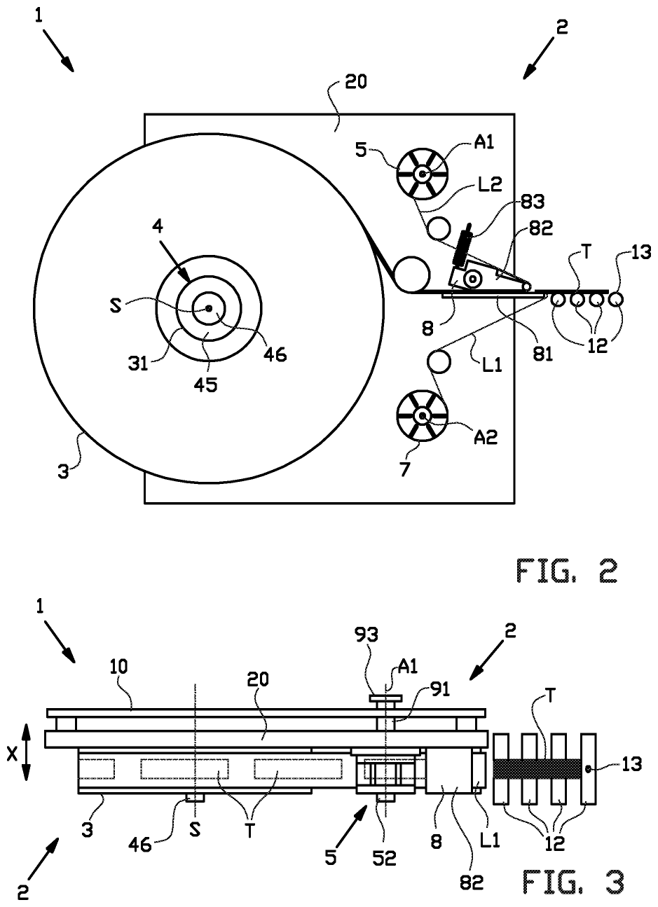

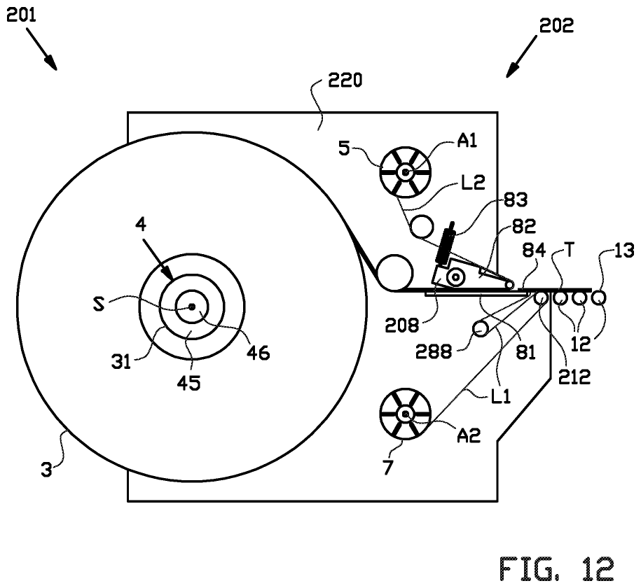

FIG. 12 shows an alternative let off station 201 which differs from the aforementioned let off station 1 of FIG. 2 in that it has a peeler 208 in which the inside liner L1 is pulled around the lower peeling edge 84 of the peeler 208 and shortly thereafter is returned underneath the tire component T to continue along the path of said tire component T and to reliably guide said tire component T over at least one receiving member 212 of the one or more receiving members 12, 212. More in particular, instead of feeding the inside liner L1 directly to the second liner reel 7, the peeler 208 comprises a return roller 288 around which the inside liner L1 is return towards the first receiving member 212 of the one or more receiving members 12, 212. This configuration may prevent that the tire component T is pulled with the inside liner L1 into the small gap between the lower peeling edge 84 and the receiving members 12. Instead, the returning inside liner L1 exerts an upward force onto the tire component T deflecting and/or guiding the tire component T onto the first receiving member 212. The inside liner L1 is again peeled off the tire component T after the first receiving member 212 and ultimately collected on the second liner reel 7. Because the inside liner L1 has already been peeled off and detached once from the tire component T, it is less likely to stick to the inside liner L1 when it is permanently peeled away from the tire component T after the first receiving member 212.

Preferably, the cassette frame 220 is extended to include a part that carries the first receiving member 212 so that the inside liner L1 can already be prepared along the entire path from the stock reel 3 up to the second liner reel 7 prior to placing the cassette 202 on the receiving frame of the let off station.

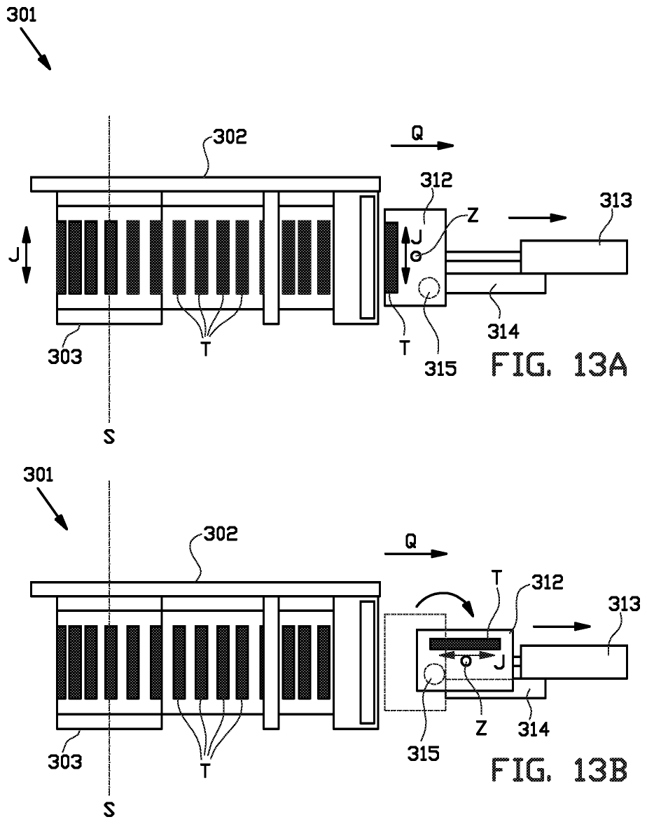

FIGS. 13A and 13B show an alternative let off station 301 for supplying a tire component T to a tire building machine. The tire component T is again an RFID tag T. The alternative let off station 301 differs from the previously discussed let off station 1 in that it is arranged or configured for receiving or holding an alternative cassette 302 in which the orientation of the RFID tags is rotated over ninety degrees with respect to the orientation of the RFID tags in the previously discussed cassette 2. In particular, it can be observed that the RFID tags T are elongated in a longitudinal direction which is parallel or substantially parallel to the stock reel axis S when the RFID tags T are stored on the stock reel 303. The advantage of such an orientation is that more RFID tags T can be stored on the same stock reel 303. The alternative let off station 301 further comprises a supply table 312 for presenting the RFID tag T to the tire building machine (not shown). The alternative cassette 302 is arranged for transferring the RFID tag T to the supply table in a transfer direction Q.

The supply table 312 is rotatable about a vertical axis Z between a receiving position, as shown in FIG. 13A, for receiving the RFID tag T in a receiving orientation from the cassette 302 and a supply position, as shown in FIG. 13B, for presenting the RFID tag T in a supply orientation to the tire building machine. The receiving position and the supply position are offset over an angle in the range of eighty to one-hundred degrees about the vertical axis Z.

The alternative let off station 301 further comprises an actuator 313 for rotating the supply table 312 about the vertical axis Z. Hence, the rotation can be automated. In this example, the actuator 313 is a linear actuator, i.e. a pneumatic or hydraulic piston, for moving the supply table 312 along a linear path, parallel to the transfer direction Q. The supply table 312 remains rotatable about the vertical axis Z relative to the linear actuator 312, during the movement along the linear path. In particular, the vertical axis Z moves with the supply table 312 along the linear path. The supply table 312 comprises a cam 315 at a position spaced apart from the vertical axis Z. The alternative let off station 301 further comprises an arm 314 for contacting the cam 315 when the supply table 312 is moved along the linear path. The relative movement between the supply table 312 and the arm 314 and the off-center position of the cam 315 with respect to the vertical axis Z and the contact between the arm 314 and the cam 315 causes the rotation of the supply table 312 about the vertical axis Z.

In this exemplary embodiment the arm 314 is stationary. In particular, the arm 314 is strategically positioned to be in the way of the cam 315 and to contact said cam 315 in a direction opposite to the transfer direction Q as the supply table 312 moves past said arm 314. The stroke of the linear actuator 313 and/or the length of the arm 314 are adapted or chosen so that the supply table 312 rotates over approximately or exactly ninety degrees about the vertical axis Z as a result of the contact between the arm 314 and the cam 315.

A method for supplying the RFID tag T to a tire building drum will be elucidated briefly below with reference to FIGS. 13 and 13B.

FIG. 13A shows the situation in which the RFID tag T is transferred onto the supply table 312 in the transfer direction Q with the longitudinal direction of the RFID tag T in a receiving orientation transverse or perpendicular to said transfer direction Q. The supply table 312 is in the receiving position.

FIG. 13B shows that the situation in which the supply table 312, after receiving the RFID tag T onto the supply table 312 in the transfer direction Q, is rotated from the receiving position to the supply position until the longitudinal direction of the RFID tag T is in a supply orientation parallel or substantially parallel to the transfer direction Q. The RFID tag T can subsequently be picked up by a gripper of the tire building machine (not shown) for placement on a substrate, in particular a rubber substrate such as a sidewall, a body ply or a breaker ply.

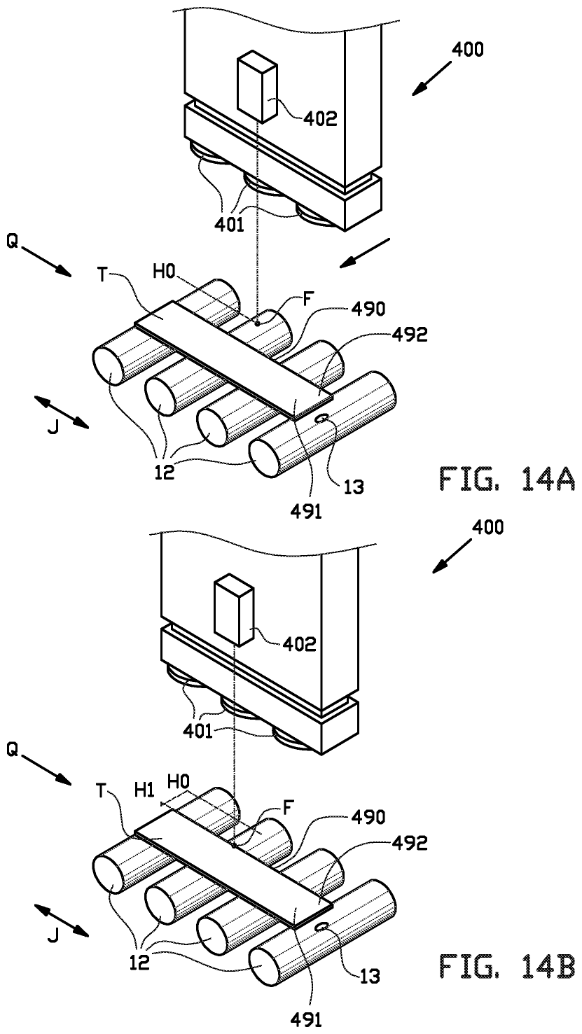

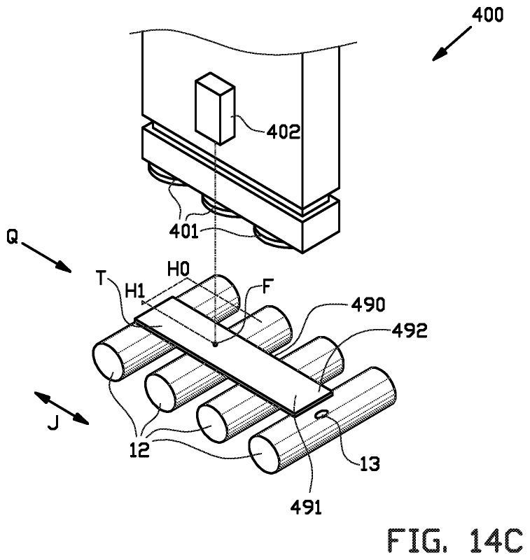

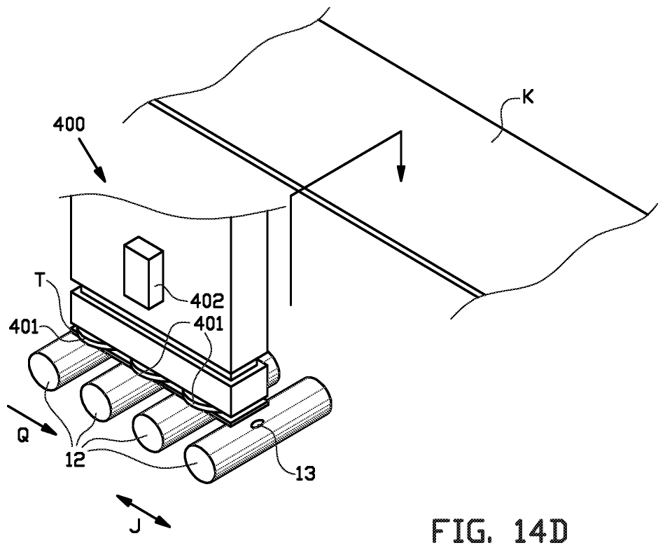

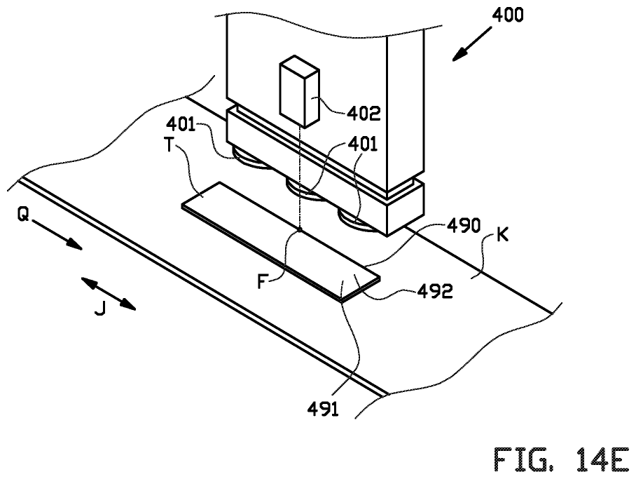

FIGS. 14A-14E show the steps of a method for locating and measuring a tire component T, in particular, the previously mentioned RFID tag T in the let off station 1, 101, 201, 301 according to any one of the aforementioned embodiments and/or on a substrate within the tire building machine, in particular on a rubber substrate such as a sidewall, a body ply or a breaker ply.

FIG. 14A shows the situation in which the RFID tag T is transferred onto a supply surface, in particular a supply surface formed by the previously discussed supply members 12 in the transfer direction Q. The RFID tag T is presented to the tire building machine (not shown) in a supply orientation with the longitudinal direction J of the RFID tag T parallel or substantially parallel to the transfer direction Q. The RFID tag T has a contour 490, a bottom surface 491, an upper surface 492 and a thickness between the bottom surface 491 and the upper surface 492, i.e. in a vertical direction.

As shown in FIG. 14A, the let off station or the tire building machine further comprises a gripper 400 with one or more gripping elements 401, in this particular example in the form of suction cups. The gripper 400 is movable into a pickup position, as shown in FIG. 14D, directly above the RFID tag T for pickup up said RFID tag T from the supply surface with the one or more gripping elements 401. The gripper 400 is subsequently movable to a placement position, as shown in FIG. 14E, at or near a substrate K for tire building, for positioning of said RFID tag T in a predetermined position on said substrate K.

In order to locate the RFID tag T on the one or more receiving members 12, the let off station or the tire building machine is further provided with a laser measurement unit 402. In this exemplary embodiment, the laser measurement unit 402 is associated with, attached to and/or integrated with the gripper 400. As such, the laser measurement unit 402 can move together or in unison with the gripper 400 towards the pickup position and the placement position.

As shown in FIG. 14A, the laser measurement unit 202 is configured for projecting a laser beam, hereafter referred to as the ‘laser projection’ F, in the form of a laser spot, a laser line or another suitable projection form. The laser projection F can be observed by an optical sensor, e.g. a camera, to determine the three dimensional position of the laser projection F relative to the laser measurement unit 402 and/or the gripper 400.

The laser measurement unit 402 is moved together with the gripper 400 across the support surface. Initially, the laser projection F is located on the support surface itself, outside of the contour 490 of the RFID tag T. The laser measurement unit 402 can now determine a height of the support surface, hereafter referred to as the ‘base height’ H0.

As shown in FIG. 14B, the laser measurement unit 402 is moved further together with the gripper 200 across the support surface until the laser projection F intersects with the contour 490 of the RFID tag T. The laser measurement unit 402 will detect a significant change or a step in the height of the laser projection F. The new height can be representative of the height of the top surface 492 of the RFID tag T, hereafter referred to as the ‘component height’ H1.

The laser measurement unit 402 can now calculate the thickness of the RFID tag T by subtracting the base height H0 from the component height H1.

The component height H1 may be measured at the contour 490 of the RFID tag T, as shown in FIG. 14B, or within the contour 490 of the RFID tag T, as shown in FIG. 14C. The detection of the component height H1 at the contour 490 of the RFID tag T can further be used to identify and/or detect the position said contour 490 and, therefore, determine the position of the RFID tag T on the support surface. This can improve the accuracy of the pickup and the subsequent placement of the RFID tag T.

The same laser measurement unit 402 can additionally or alternatively be used to check the positioning of the RFID tag T on the substrate K after placement in FIG. 14E, i.e. by detecting the contour 490 again after the gripper 400 has released the RFID tag T onto the substrate K.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 let off station
10 receiving frame
11 coupling member
12 receiving roller
13 sensor
2 cassette
20 cassette frame
21 coupling member
22 pawl
3 stock reel
30 stock reel body
31 mounting opening
32 key slot
4 stock reel mount
40 clamping wall
41 first slot
42 second slot
43 wall segment
44 rear wall
45 wedge
46 retaining member
47 key
5 first liner reel
50 core
51 support wall
52 retaining member
53 spline bushing
54 biasing member
55 ratchet gear
56 threaded element
59 first side flange
60 shell
61 collection wall
62 first slot
63 second slot
64 wall segment
65 front wall
66 collection surface
69 second side flange
7 second liner reel
8 peeler
81 lower peeler member
82 upper peeler member
83 bias member
84 lower peeling edge
85 upper peeling edge
86 first peeling roller
87 second peeling roller
9 liner reel drive
91 first spline shaft
92 second spline shaft
93 first drive pulley
94 second drive pulley
95 drive belt
96 motor
105 alternative first liner reel
150 core
153 spline bushing
109 liner reel drive
191 first spline shaft
193 first drive pulley
195 housing
196 biasing member
201 alternative let off station
212 first receiving roller
202 alternative cassette
208 alternative peeler
288 return roller
301 further alternative let off station
302 further alternative cassette
303 further alternative stock reel
312 supply table
313 actuator
314 arm
315 cam
400 gripper
401 gripper elements
402 laser measurement unit
490 contour
491 lower surface
492 upper surface
A1 first liner reel axis
A2 second liner reel axis
B bias direction
C receiving direction
D1 first pulley diameter
D2 second pulley diameter
D3 external diameter
D4 internal diameter
D5 first roller diameter
D6 second roller diameter
E leading end
F laser spot
G1 first roller axis
G2 second roller axis
H taper angle
H1 base height
H2 component height
J longitudinal direction
K substrate
L1 inside liner
L2 outside liner
M mounting direction
N removal direction
P peeler axis
Q transfer direction
R radial direction
S stock reel axis
RFID tag
V release direction
W wedge direction
W1 male spline width
W2 female spline width
X axial direction
Z vertical axis

1.-24. (canceled)

25. A liner reel for collecting a liner, wherein the liner reel comprises a core and a shell that is concentrically mountable to said core for rotation together with said core about a liner reel axis, wherein the shell comprises a collection wall that extends in a circumferential direction about the liner reel axis when the shell is mounted to the core, wherein the collection wall is arranged for receiving the liner, wherein the core comprises one or more support members for supporting the collection wall at least with a vector component in a radial direction perpendicular to the liner reel axis, wherein said collection wall is at least partially contractible in said radial direction when the shell is removed from the core, wherein the shell has a first side that is open in a mounting direction parallel to the liner reel axis so that the shell can be slid over the core and a second side facing away from the core in a removal direction opposite to the mounting direction when the shell is mounted to the core, wherein the shell comprises a plurality of first slots dividing said collection wall in the circumferential direction into a plurality of wall segments that are interconnected only at the second side, wherein the plurality of wall segments are individually flexible in the radial direction at the first side, the shell further comprises a front wall interconnecting the plurality of wall segments at the second side, wherein the front wall comprises a plurality of second slots which are continuous with the plurality of first slots and which extend in the radial direction towards the liner reel axis when the shell is mounted to the core.

26. The liner reel according to claim 25, wherein the collection wall is discontinuous in the circumferential direction and is, as a result thereof, contractible in the radial direction.

27. The liner reel according to claim 25, wherein the plurality of first slots extends mutually parallel and parallel to the liner reel axis when the shell is mounted to the core.

28. The liner reel according to claim 25, wherein the one or more support members comprises a support wall extending in the circumferential direction.

29. The liner reel according to claim 28, wherein the shell is mountable to said core in a mounting direction parallel to the liner reel axis, wherein the support wall tapers conically with respect to the liner reel axis in a removal direction opposite to the mounting direction.

30. The liner reel according to claim 29, wherein the collection wall tapers in the mounting direction.

31. The liner reel according to claim 30, wherein the collection wall defines an externally facing collection surface, wherein the collection wall tapers at a taper angle that is chosen such that, when the collection wall is supported on the conically tapering support wall, the collection surface is cylindrical.

32. The liner reel according to claim 25, wherein the liner reel further comprises a retaining member for retaining the shell in an axial direction parallel to the liner reel axis to the core when the shell is mounted to said core.

33. The liner reel according to claim 25, wherein the liner reel comprises a first side flange and a second side flange projecting in the radial direction outside of the collection wall on opposite sides of the collection wall in an axial direction parallel to the liner reel axis when the shell is mounted to the core, wherein the first side flange is associated with the core and the second side flange is associated with the shell.

34. The liner reel according to claim 25, wherein the liner reel comprises one of a spline bushing and a spline shaft at the liner reel axis for coupling the core to the other of spline bushing and the spline shaft.

35. The liner reel according to claim 34, wherein the spline bushing is arranged for receiving the spline shaft in a receiving direction parallel to the liner reel axis, wherein the spline bushing is movable in the receiving direction from a coupling position to a retracted position, wherein the liner reel further comprises a biasing member to bias the spline bushing from the retracted position towards the coupling position.

36. A cassette comprising the liner reel as claimed in claim 25 as a first liner reel for collecting a first liner, wherein the cassette comprises a cassette frame for holding the first liner reel and a stock reel in tandem.

37. The cassette according to claim 36, wherein the cassette further comprises a second like liner reel as a second liner reel for collecting a second liner.

38. The cassette according to claim 36, wherein the first liner reel comprises a ratchet gear rotatable about the liner reel axis of said first liner reel, wherein the cassette comprises a pawl that is rotatable relative to the cassette frame to form a ratchet mechanism together with the ratchet gear.

39. The cassette according to claim 36, wherein the first liner reel comprises one of a spline bushing and a spline shaft at the liner reel axis for coupling the core to the other of the spline bushing and the spline shaft, wherein the spline bushing is arranged for receiving the spline shaft in a receiving direction parallel to the liner reel axis, wherein the spline shaft is movable in a direction opposite to the receiving direction from a coupling position to a retracted position, wherein the cassette further comprises a biasing member to bias the spline shaft from the retracted position towards the coupling position.

40. A let off station comprising the cassette as claimed in claim to claim 36 and a receiving frame for mounting of said cassette, wherein the let off station comprises a first spline shaft for driving the first liner reel.

41. The let off station according to claim 40, wherein the first liner reel comprises a spline bushing at the liner reel axis of said first liner reel for coupling the core to the first spline shaft, wherein the spline bushing is arranged for receiving the first spline shaft in a receiving direction parallel to the liner reel axis of the first liner reel, wherein the spline bushing is movable in the receiving direction from a coupling position to a retracted position over a distance that is at least equal to the length of the first spline shaft that is received into the spline bushing in the receiving direction when the cassette is mounted to the receiving frame and the spline bushing is aligned with the first spline shaft in the coupling position.

42. The let off station according to claim 40, wherein the let off station comprises a second spline shaft, spaced apart and parallel to the first spline shaft, for driving a second liner reel.

43. The let off station according to claim 42, wherein the first spline shaft has an external diameter, and the spline bushing has an internal diameter, wherein the internal diameter is at least one-hundred-and-three percent of the external diameter.

44. The let off station according to claim 42, wherein the first spline shaft comprises male splines having a male spline width, wherein the spline bushing comprises female splines having a female spline width, wherein the female spline width is at least one-hundred-and-five percent of the male spline width.

45. The let off station according to claim 42, wherein the let off station further comprises a liner reel drive for driving the first liner reel and a second liner reel, wherein the liner reel drive is arranged for driving one of the first liner reel and the second liner reel faster than the other of the first liner reel and the second liner reel.

46. The let off station according to claim 45, wherein the liner reel drive comprises a first pulley connected to the first spline shaft to rotate the first liner reel, a second pulley connected to a second spline shaft to rotate the second liner reel and an endless drive element arranged in a loop around the first pulley and the second pulley, wherein one of the first pulley and the second pulley has a diameter greater than the diameter of the other of the first pulley and the second pulley.

47. A method for collecting a liner on a liner reel as claimed in claim 25, wherein the method comprises the steps of:
mounting the shell concentrically to the core;
connecting a leading end of the liner to the shell;
rotating the shell together with the core; and
receiving windings of the liner around the collection wall;
wherein the collection wall at least partially contracts in the radial direction when the shell is removed from the core, wherein the method further comprises the step of:
removing the windings of the liner from the shell when the collection wall is at least partially contracted in the radial direction.

48. The method according to claim 47, wherein the shell comprises a first slot extending in the collection wall parallel to the liner reel axis when the shell is mounted to the core, wherein the step of connecting the leading end of the liner to the shell comprises the steps of:
inserting the leading end of the liner through the first slot so that it protrudes through the collection wall in the radial direction at the inside of said collection wall when the shell is not yet mounted to the core; and
clamping the leading end between the collection wall and the core when the shell is mounted to the core.
